(19) United States
(12) Patent Application Publication
(10) Pub. No.: US 2018/0047069 A1
(43) Pub. Date: Feb. 15, 2018

(54) SYSTEM AND METHOD FOR FULFILLING AN INQUIRY THROUGH AN ONLINE STRUCTURE

(71) Applicant: MASTERCARD INTERNATIONAL INCORPORATED, Purchase, NY (US)

(72) Inventors: Vijin Venugopalan, Singapore (SG); Benjamin Charles Gilbey, Singapore (SG); Prashant Sharma, Madison, NJ (US)

(21) Appl. No.: 15/234,957

(22) Filed: Aug. 11, 2016

(51) Int. Cl. G06Q 30/02; H04L 29/06; H04L 29/08

(52) U.S. Cl. CPC G06Q 30/0279; H04L 67/10; H04L 63/166

(57) ABSTRACT

Systems, methods, and software products, fulfill a request through an online structure. The request for a request amount is received within the online structure from a requestor. The request amount is divided by a split amount to determine a chosen number of potential donors from which to request donations. The chosen number of potential donors are selected from a pool of potential donors and are each sent a request for the split amount in a communication based upon a protocol of the online structure and via a network of the online structure. A response, received from each of the selected chosen number of potential donors via the network using another communication of the protocol. When the response includes the donation amount, the donation amount is collected as received donations within the online structure. The received donations are sent to the requestor when the requested amount is fulfilled.

### BACKGROUND

Crowdsourcing allows an entity to collect funds for a cause. Such crowdsourcing (crowdfunding) typically requires the services of a third party (e.g., Kickstarter, Indiegogo) to help raise awareness of the cause and to ultimately raise funds for the cause. The third party relies upon responses to advertising of the cause and volunteers that are willing to donate to the cause.

### SUMMARY

An existing network is enhanced to collect donations to fulfill a donation request. The donation request, received via a cloud interface from a requestor, contains a request amount that is divided into smaller portions (split amount) and requests for these smaller portions are sent out to potential donors of the existing network. Donations are received via the existing network, and when the collected total of donations matches the requested amount, the requested amount is sent to the requestor.

In one embodiment, a computer-implemented method fulfills a request through an online structure. The request for a request amount is received within the online structure from a requestor. The request amount is divided by a split amount to determine a chosen number of potential donors from which to request donations. The chosen number of potential donors are selected from a pool of potential donors. A request for the split amount is included within a communication based upon a protocol of the online structure and transmitted via a network of the online structure to each of the selected chosen number of potential donors. A response is received from each of the selected chosen number of potential donors via the network and using another communication of the protocol. When the response includes the donation amount, the donation amount is collected as received donations within the online structure. The received donations are sent to the requestor when the requested amount is fulfilled.

In another embodiment, a system fulfills a request through an online structure. The system includes a network implementing a protocol, an application programming interface (API) for communicating with a mobile device to receive a donation request from a requestor, an evaluator for evaluating legitimacy of the donation request, a pool of donor records, where each donor record identifies a potential donor, and a manager implemented as machine readable instructions that when executed by a processor of the system are capable of (a) determining a chosen number of potential donors based upon the donation request and a split amount, (b) selecting the chosen number of potential donors from the pool, (c) sending a request for the split amount to each of the selected potential donors, (d) collecting donations from the selected potential donors; and (e) sending the collected donations to the requestor.

In another embodiment, a non-transitory computer readable medium has computer executable instructions stored thereon that, when executed by a digital processor, perform the method of fulfilling a request through an online structure. The non-transitory computer readable medium includes instructions for receiving, within the online structure, a request from a requestor for a request amount, instructions for dividing the request amount by a split amount to determine a chosen number of potential donors from which to request donations, instructions for selecting the chosen number of potential donors from a pool of potential donors, instructions for including a request for the split amount within a communication based upon a protocol of the online structure, instructions for transmitting the communication via a network of the online structure to each of the selected chosen number of potential donors, instructions for receiving, via the network and using another communication of the protocol, from each of the selected chosen number of potential donors, a response, instructions for collecting a donation amount as received donations within the online structure when the response includes the donation amount, and instructions for sending the received donations to the requestor when the requested amount is fulfilled.

### BRIEF DESCRIPTION OF THE FIGURES

FIG. 1 shows one example system for fulfilling an inquiry/request through an online structure, in an embodiment.

FIG. 2 shows the donor pool of FIG. 1 in further example detail, in an embodiment.

FIG. 3 shows the request of FIG. 1 in further example detail.

FIG. 4 is a flowchart illustrating one example method for fulfilling an inquiry/request through an online structure, in an embodiment.

### DETAILED DESCRIPTION OF THE EMBODIMENTS

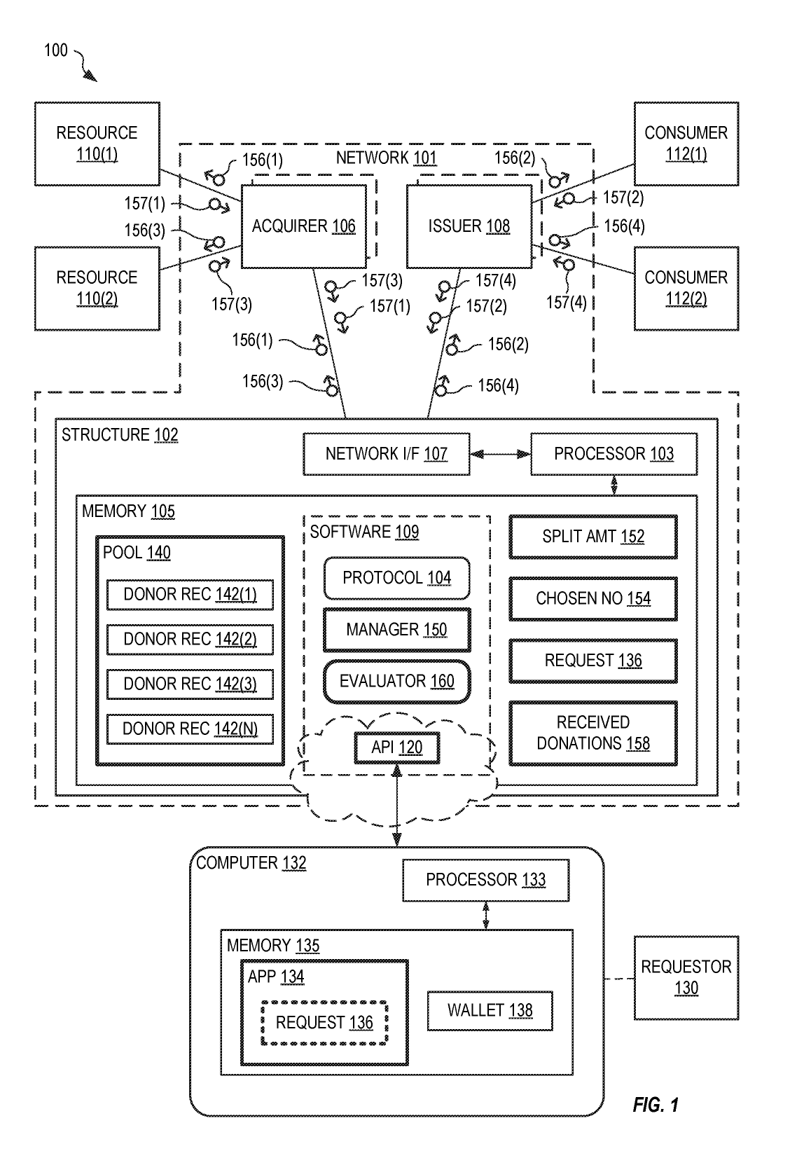

FIG. 1 shows one example system 100 for fulfilling an inquiry/request 136 through an online structure 102. Online structure 102 is for example implemented by one or more networked computer servers and is shown with a processor 103 communicatively coupled with memory 105 and a network interface 107. Processor 103 represents one or more digital processors and memory 105 represents one or more of volatile memory (e.g., RAM) and non-volatile memory (e.g., ROM, FLASH, magnetic media, optical media, and so on). Although shown within structure 102, memory 105 may be, at least in part, implemented as network storage that is external to structure 102 and accessed via network interface 107. Network interface 107 may be implemented as one or both of a wired network interface and a wireless network interface, as known in the art. Software 109 includes machine readable instructions, stored within a non-transitory portion of memory 105, that are executed by processor 103 to perform the functionality of structure 102 as described herein.

Network 101 facilitates secure collecting of donations to fulfill a request and is formed in part by one or more of the Internet, wireless networks, wired networks, local networks, and so on. Network 101 provides remuneration interaction between a plurality of resources 110, via associated acquirers 106, and a plurality of consumers 112, via associated issuers 108. For the examples shown herein, resources 110 and consumers 112 have indicated their willingness to make donations through structure 102.

Using a protocol 104, network 101 and structure 102 cooperate to fulfill agreements between resources 110 (via an associated acquirer 106 of the resource) and consumers 112 (via an associated issuer 108 of the consumers). For example, network 101 may include a network switch that handles communication between acquirers 106 and issuers 108. In one embodiment, structure 102 represents a network, such as MasterCard® and Visa®, that operates a scheme for, e.g., debit or credit cards, that are linked to accounts of the resources 110 and consumers 112, and where protocol 104 is implemented as defined by ISO 8583. In one embodiment, structure 102 and protocol 104 implement a tokenization service (e.g., MasterCard Digital Enablement Service) that improves security of the agreements. In FIG. 1, structure 102 is shown operating as a four party scheme, where acquirer 106 and issuer 108 are different entities. Structure 102 may also operate as a three party scheme, where acquirer 106 and issuer 108 are the same entity (e.g., American Express®, Discover Card®, and Diners Club®). Structure 102 is enhanced to also support soliciting and collecting of donations to fulfill a request 136.

When consumer 112 enters into an agreement with resource 110 (which can be, for example, a merchant or a service provider), structure 102 uses protocol 104 to implement messaging (e.g., a transaction) between resource 110, acquirer 106, issuer 108, and consumer 112 to fulfill an obligation (e.g., remuneration) of the agreement. For example, the agreement may result from consumer 112 requesting goods or services from resource 110, wherein the obligation is for consumer 112 to remunerate resource 110 for the cost of the goods or services. However, these schemes, as previously known, do not facilitate soliciting and collection of donations.

In embodiments, to facilitate such donations, structure 102 includes an application programming interface (API) 120 that provides an external interface (e.g., a cloud interface to the Internet) that allows an external or remote computer 132 to communicate securely with structure 102. In one embodiment, API 120 is implemented as JavaScript Object Notation (JSON) FRE-API, and may implement a mutual transport layer security (TLS) protocol, as known in the art.

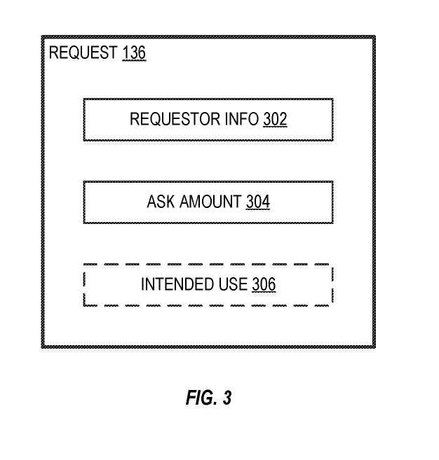

Computer 132 includes a digital processor 133 that is communicatively coupled with a memory 135. Processor 133 represents one or more digital processors and memory 135 represents one or more of volatile memory (e.g., RAM) and non-volatile memory (e.g., ROM, FLASH, magnetic media, optical media, and so on). In one embodiment, computer 132 is a mobile computer, such as one of a laptop, notebook, tablet, and smartphone, that is used by a requestor 130. In another embodiment, computer 132 is a stationary computer, such as a desktop computer, that includes a web browser, wherein API 120 provides a web interface that facilitates creation of request 136 by requestor 130. Requestor 130 is for example a person or entity in need of funds, such as for funding a startup company, or is someone looking for funding for survival due to hardship. Requestor 130 downloads an app 134 onto computer 132 that enables computer 132 to communicate securely with structure 102 via API 120. App 134 is software, stored in a non-transitory portion of memory 135, that includes machine readable instructions that are executed by processor 133 to improve functionality of computer 132 and to allow communication with structure 102 via API 120. Requestor 130 interacts with app 134 to generate a request 136 that is uploaded to structure 102 via API 120. In one embodiment, app 134 provides a graphical user interface that prompts requestor 130 to enter the necessary data to prepare request 136. API 120 thereby allows any computer running app 134 to generate and send request 136 to structure 102. Request 136 defines a request amount (see request amount 304 of FIG. 3) that defines an amount (e.g., an ask amount) of the donations being requested by requestor 130.

Structure 102 also includes a manager 150 that operates to fulfill request 136. Manager 150 is implemented within software 109 of structure 102 and includes machine readable instructions stored within memory 105 and executed by a digital processor 103 to provide the functionality described herein.

Each resource 110 and consumer 112 (which, as contemplated herein, could also be an entity such as a charitable organization) indicates consent to receiving donation requests (e.g., a solicitation for a donation amount) from structure 102, and manager 150 adds a donor record 142 to pool 140 identifying each consenting resource or consumer as a potential donor. In one embodiment, during creation of an account associated with one of acquirer 106 and issuer 108, a corresponding one of resource 110 and consumer 112, respectively, provides information to complete donor record 142. In another embodiment, resources 110 and consumers 112 consent to receiving donation requests (e.g., a solicitation for a donation amount) from structure 102 after their associated accounts have been formed. Advantageously, structure 102 may thereby utilize the existing network of resources 110 and consumer 112 to fulfill request 136.

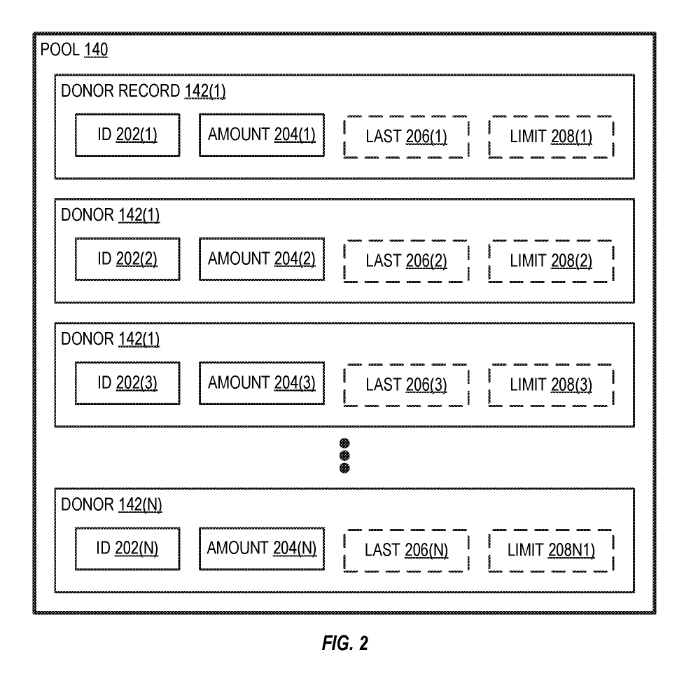

FIG. 2 shows pool 140 of FIG. 1 in further example detail, illustrating each donor record 142 as including: an ID 202 that identifies the potential donor (e.g., resource 110 or consumer 112), an amount 204 that indicates a maximum amount for any solicitation and, in embodiments, a last 206 that indicates a last time when the donor made a donation, and a limit 208 indicating a maximum amount the donor is willing to donate each period (e.g., each week, month, or year). When included, last 206 and limit 208 may be used when selecting potential donors from pool 140. In one embodiment, during registration of resource 110 by acquirer 106, amount 204 is determined based upon a type of resource 110. For example, where resource 110 is a quick service restaurant, amount 204 is set to one thousand dollars. In another embodiment, during registration of consumer 112 by issuer 108, consumer 112 defines amount 204 during registration of the associated account. For example, consumer 112 defines amount 204 when registering their credit/debit card with issuer 108. Donor records 142 may include other information without departing from the scope hereof. In one embodiment, pool 140 is implemented as a database and donor records 142 are sorted based upon one or more of amount 204, last 206, and limit 208 to facilitate selection of donors more likely to donate.

In one embodiment, structure 102 includes two pools 140, one corresponding to resources 110 that consent to receiving donation requests, and one corresponding to consumers 112 that consent to receiving donation requests, thereby allowing one or both of requestor 130 and structure 102 to choose from which pool 140 requestors are selected. In another embodiment, donor record 142 indicates a type of the consenting donor (e.g., resource 110 or consumer 112), thereby allowing one or both of requestor 130 and structure 102 to choose the type of donor to select.

FIG. 3 shows request 136 of FIG. 1 in further example detail. In one embodiment, request 136 is a data structure having fields that include requestor information 302, a request amount 304, and optionally an intended use 306. Requestor information 302 includes information (e.g., a name and address, or company name) of requestor 130. In one embodiment, requestor information 302 includes a requestor ID corresponding to requestor 130, where requestor 130 is enrolled with structure 102. Request amount 304 defines an amount (e.g., a financial value) being requested by requestor 130. For example, request amount 304 may define total donations requested by requestor 130. Intended use 306, if included, defines the intended use for the requested donation. Request 136 may include other information without departing from the scope hereof. For example, request 136 may include evidence of hardship where requestor 130 has fallen on hard time, or request 136 may include a business plan where requestor 130 seeks funds to start a new business.

Structure 102 may include an evaluator 160, implemented as machine readable instructions stored within memory 105 and executed by processor 103, that evaluates and validates request 136. In one example of operation, manager 150 receives request 136 from computer 132, and invokes evaluator 160 to evaluate whether request 136 is genuine and should be fulfilled by structure 102. In one embodiment, evaluator 160 interacts with an administrator of structure 102 to determine whether request 136 is genuine and is eligible to be fulfilled by structure 102. In another embodiment, legitimacy of request 136 is based upon pre-authorization of requestor 130 and/or based upon at least one card from participating issuers. Manager 150 then, based upon request amount 304 of request 136, determines a split amount 152 (e.g., one-hundred dollars). In one embodiment, split amount 152 is preconfigured. In another embodiment, split amount 152 is determined based upon donor records 142 within pool 140. Manager 150 then divides the requested request amount 304 by split amount 152 to determine a chosen number 154 of the number of donors required to fulfill the request. For example, where request amount 304 is ten-thousand dollars, and split amount 152 is determined to be one-hundred dollars, manager 150 calculates chosen number 154 as one-hundred donors. Manager 150 then selects chosen number 154 potential donors from pool 140 based upon donor records 142, and sends a request message 156 for the split amount 152 to each donor via acquirer 106 and/or issuer 108. In response to request message 156, each potential donor sends a response message 157 containing the donated amounts, these amounts are collected as received donations 158 within structure 102. Response message 157 is transported within network 101 using protocol 104, and thereby facilitates secure transfer of donated funds. For example, information of request messages 156 and response messages 157 may be added to existing messaging of protocol 104, thereby utilizing the existing network 101 of structure 102, acquirer 106, and issuer 108.

Where selected donors decline to donate, additional donors are selected from pool 140, and request messages 156 are sent to request split amount 152 therefrom. Once received donations 158 contains sufficient funds to fulfill request 136, manager sends received donations 158 to computer 132 via API 120, where they may be stored within a wallet 138 of computer 132 for example. In one embodiment, manager 150 transfers received donations 158 to an account of requestor 130 that may be defined within request 136 for example.

In one embodiment, where received donations 158 is insufficient to fulfill request 136, after a predefined period, structure 102 sends the insufficient received donations 158 to an account of requestor 130. In another embodiment, where received donations 158 is insufficient to fulfill request 136, after a predefined period, structure 102 returns the donated amounts to the donors.

Request messages 156 and response messages 157 are implemented through protocol 104 and network 101. In the embodiment where protocol 104 implements ISO 8583, split amount 152 may be added to a data element of a communication sent from structure 102 to one of resources 110 and consumers 112 using protocol 104 and network 101, to form request message 156. Similarly, the donation may be added to the data element of another communication sent from the resource or the consumer to structure 102 using protocol 104 and network 101, to form response message 157.

In one embodiment, where resource 110 is a retail store (e.g., a grocery store), resource 110 may collect donations from customers. For example, a cashier of resource 110 may ask customers whether they are willing to donate to the request. If the customer responds affirmatively, the donation amount is added to a checkout total, such that the customer's final charge includes the donation. For example, if the checkout total is ten dollars, and the donation amount is two dollars, then the customer's final charge is twelve dollars. In one embodiment, a point of sale device (as used by the cashier for example) of resource 110 is configured to send the donation amount, using protocol 104 (i.e., within the data element of the ISO 8583 protocol) to structure 102, wherein structure 102 charges the consumer the total amount (e.g., twelve dollars), manager 150 adds the donation amount to received donations 158, and the balance (e.g., ten dollars) forms the customer's payment to resource 110.

In another similar embodiment, where resource 110 is a retail store (e.g., a grocery store), resource 110 receives a request for split amount 152 (e.g., $100) from structure 102 and collects donations for smaller amounts (e.g., $2) from customers. For example, a cashier of resource 110 may ask customers whether they are willing to donate a small amount to the request. If the customer responds affirmatively, the donation amount is added to a checkout total, such that the customer's final charge includes the donation. Resource 110 accumulates donated amounts and when the accumulated amount reaches split amount 152, resource 110 sends the accumulated amount to structure 102. Structure 102 may also specify a time constraint for returning split amount 152 to structure 102. Where resource 110 has not collected the full amount within the specified time constraint, the resource sends any collected amount to structure 102. Structure 102 may then select an additional potential donor from pool 140 and send request message 156 for the remaining portion of split amount 152 to the additional potential donor.

In one embodiment, when registering a credit/debit card with issuer 108, each consumer 112 agrees to donate a small amount each time that the card is used. For example, consumer 112 may agree to donate one dollar each time they user a credit card for a purchase. Issuer 108 accumulates these donated amounts and, when the accumulated amount reaches the split amount 152, issuer 108 sends the accumulated amount to structure 102.

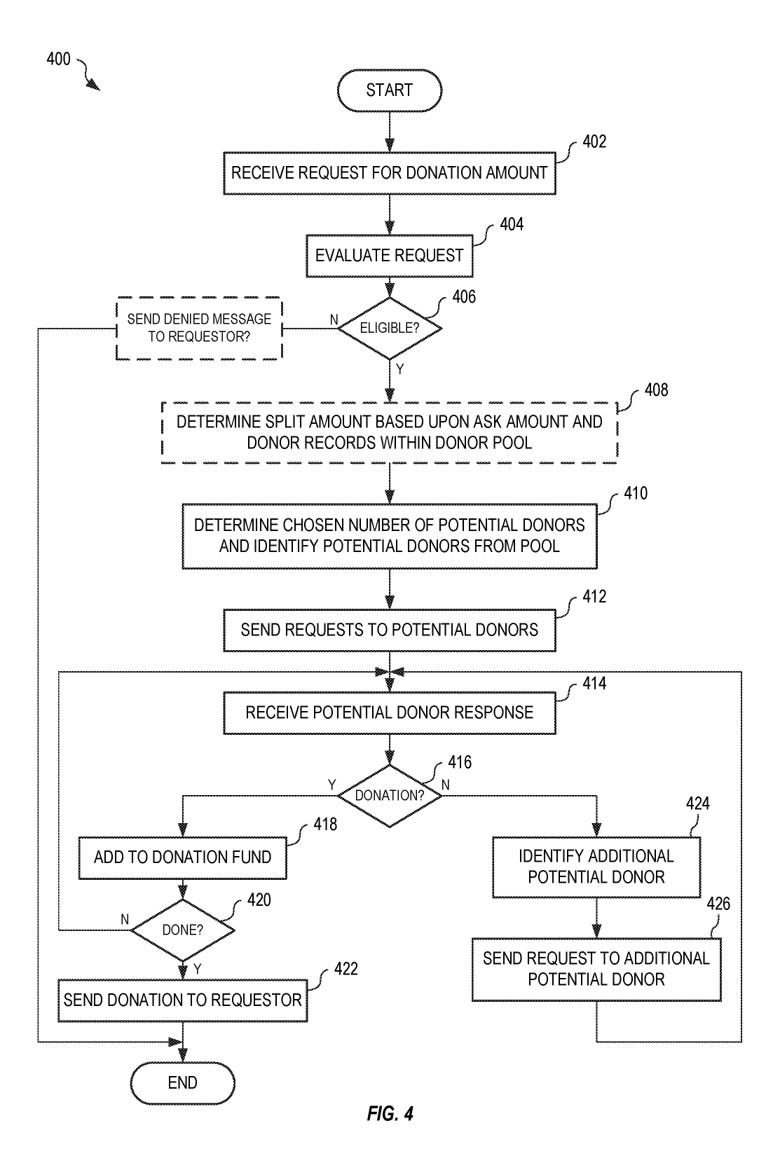

FIG. 4 is a flowchart illustrating one example method 400 for fulfilling a request through an online structure. FIGS. 1, 2, 3 and 4 are best viewed together with the following description. Method 400 is for example implemented within manager 150 of structure 102.

In step 402, method 400 receives a request for a donation amount. In one example of step 402, manager 150 receives request 136 via API 120. In step 404, method 400 evaluates the request. In one example of step 404, manager 150 invokes evaluator 160 to evaluate request 136 and to decide if request 136 is genuine and should be fulfilled.

Step 406 performs a decision. If, in step 406, method 400 determines that the request is eligible for fulfillment, method 400 continues with step 408; otherwise, method 400 terminates, optionally sending a message to requestor 130 indicating the rejection of the request.

In embodiments envisioned by step 408, method 400 determines a split amount based upon the request amount and donor records within the donor pool. In one example of step 408, manager 150 determines split amount 152 based upon request amount 304 of request 136 and amount 204 of donor records 142 within pool 140. In step 410, method 400 determines a chosen number of potential donors and identifies potential donors from a pool. In one example of step 410, where request amount 304 is ten-thousand dollars and split amount 152 is one-hundred dollars, manager 150 determines chosen number 154 as one-hundred and selects chosen number 154 (one-hundred) potential donors from pool 140 based upon donor records 142.

In step 412, method 400 sends requests to the selected potential donors. In one example of step 412, manager 150 utilizes protocol 104 to send request messages 156 to each selected donor via the corresponding acquirer 106 or issuer 108 to solicit a donation. In the example of FIG. 1, manager 150 sends request messages 156(1) and 156(3) via acquirer 106 to resources 110(1) and 110(2), and sends request messages 156(2) and 156(4) via issuer 108 to consumers 112(1) and 112(2).

In step 414, method 400 receives potential donor response. In one example of step 414, manager 150 receives response messages 157 from resources 110 and consumers 112 that each received one request message 156.

Step 416 performs a decision. If, in step 416, method 400 determines that a donation was received within the response, method 400 continues with step 418; otherwise, method 400 continues with step 424. For example, where response message 157 includes a donation amount, method 400 continues with step 418. Where response message 157 declines to donate (i.e., the donation amount is zero), method 400 continues with step 424.

In step 418, method 400 adds the donation amount within response message 157 to received donations 158. Step 420 performs a decision. If, in step 420, method 400 determines that request 136 is fulfilled, method continues with step 422; otherwise, method 400 continues with step 414 to receive further response messages 157. In step 422, method 400 sends the donation to the requestor. In one example of step 422, manager 150 sends received donations 158 to computer 132 via API 120, where computer 132 stores the donation in wallet 138. Method 400 then terminates.

In step 424, method 400 identifies additional potential donors. In one example of step 424, manager 150 selects an additional potential donor from pool 140 based upon donor records 142. In step 426, method 400 sends a request to the additional potential donor. In one example of step 426, manager 150 sends request message 156 to resource 110 via acquirer 106. Method 400 then continues with step 414.

Steps 414 through 426 repeat until request 136 is fulfilled and the received donations 158 are sent to requestor 130. Method 400 then terminates.

Steps of method 400 may have alternate structure and be performed in a different order without departing from the scope hereof. For example, the identifying of potential donors, sending of requests, and receiving of donations may be grouped. In another example, structure 102 may receive donation amounts within response messages 157 that are different from split amount 152, wherein manager 150 determines an amount for solicitation from subsequent potential donors based upon a remaining amount required to fulfill request 136.

It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A computer-implemented method for fulfilling a request through an online structure, comprising:
receiving, within the online structure, the request for a request amount from a requestor;
dividing the request amount by a split amount to determine a chosen number of potential donors from which to request donations;
selecting the chosen number of potential donors from a pool of potential donors;
including a request for the split amount within a communication based upon a protocol of the online structure;
transmitting the communication via a network of the online structure to each of the selected chosen number of potential donors;
receiving, via the network and using another communication of the protocol, from each of the selected chosen number of potential donors, a response;
when the response includes a donation amount, collecting the donation amount as received donations within the online structure; and
sending the received donations to the requestor when the requested amount is fulfilled.

2. The method of claim 1, further comprising selecting, for each of the responses indicating no donation, an additional potential donor from the pool of potential donors and repeating the steps of including, transmitting, receiving, and collecting.

3. The method of claim 1, wherein the request is received via a cloud based API interface of the online structure and from an app running on a mobile computer.

4. The method of claim 3, the cloud based API interface and the app implementing mutual transport layer security.

5. The method of claim 1, further comprising evaluating the request to determine that it is genuine and eligible for fulfillment by the online structure, wherein the request is not fulfilled when not genuine or not eligible.

6. The method of claim 5, the step of evaluating comprising evaluating information within the request including one or more of the request amount, requestor information, and intended use, wherein the request is not eligible when any one of the request amount, requestor information, and intended use is not genuine.

7. The method of claim 1, wherein the split amount is preconfigured within the structure.

8. The method of claim 1, wherein the split amount is determined based upon donation amount limits defined by each potential donor in the pool of potential donors.

9. The method of claim 1, the protocol comprising ISO 8583.

10. The method of claim 1, wherein the network facilitates secure communication between the online structure, one or more acquirers associated with certain of the potential donors, and one or more issuers associated with certain other of the potential donors.

11. A system for fulfilling a request through an online structure, comprising:
a network implementing a protocol;
an application programming interface (API) for communicating with a mobile device to receive a donation request from a requestor;
an evaluator for evaluating legitimacy of the donation request;
a pool of donor records, where each donor record identifies a potential donor;
a manager capable of (a) determining a chosen number of potential donors based upon the donation request and a split amount, (b) selecting the chosen number of potential donors from the pool, (c) sending a request for the split amount to each of the selected potential donors, (d) collecting donations from the selected potential donors; and (e) sending the collected donations to the requestor.

12. A non-transitory computer readable medium with computer executable instructions stored thereon executed by a digital processor to perform the method of fulfilling a request through an online structure, comprising:
instructions for receiving, within the online structure, a request from a requestor for a request amount;
instructions for dividing the request amount by a split amount to determine a chosen number of potential donors from which to request donations;
instructions for selecting the chosen number of potential donors from a pool of potential donors;
instructions for including a request for the split amount within a communication based upon a protocol of the online structure;
instructions for transmitting the communication via a network of the online structure to each of the selected chosen number of potential donors;
instructions for receiving, via the network and using another communication of the protocol, from each of the selected chosen number of potential donors, a response;
instructions for collecting a donation amount as received donations within the online structure when the response includes the donation amount; and
instructions for sending the received donations to the requestor when the requested amount is fulfilled.

13. The non-transitory computer readable medium of claim 12, further comprising:
instructions for defining a time constraint for returning the split amount to the online structure; and
instructions for selecting, for each of the responses where the donation amount is less than the split amount, an additional potential donor from the pool of potential donors and repeating the instructions for including, transmitting, receiving, and collecting for the remaining portion of the split amount.

14. The non-transitory computer readable medium of claim 12, wherein the instructions for receiving comprise instructions for receiving the request via a cloud based application programming interface (API) of the online structure and from an app running on a mobile computer.

15. The non-transitory computer readable medium of claim 13, the cloud based API interface and the app implementing mutual transport layer security.

16. The non-transitory computer readable medium of claim 12, further comprising instructions for evaluating the request to determine that it is genuine and eligible for fulfillment by the online structure, wherein the request is not fulfilled when not genuine or not eligible.

17. The non-transitory computer readable medium of claim 16, the instructions for evaluating comprising instructions for evaluating information within the request including one or more of the request amount, requestor information, and intended use, wherein the request is not eligible when any one of the request amount, requestor information, and intended use is not genuine.

18. The non-transitory computer readable medium of claim 12, wherein the split amount is preconfigured within the structure.

19. The non-transitory computer readable medium of claim 12, wherein the split amount is determined based upon donation amount limits defined by each potential donor in the pool of potential donors.

20. The non-transitory computer readable medium of claim 12, wherein the network facilitates secure communication between the online structure, one or more acquirers associated with certain of the potential donors, and one or more issuers associated with certain other of the potential donors.
